(19) United States
(12) Patent Application Publication
(10) Pub. No.: US 2025/0161158 A1
(43) Pub. Date: May 22, 2025

(54) HEATING NEEDLE AND MANUFACTURING METHOD THEREFOR

(71) Applicant: Suk Yun KIM, Yongin-si, Gyeonggi-do (KR)

(72) Inventors: Suk Yun KIM, Yongin-si, Gyeonggi-do (KR); Hyon Chan JO, Yongin-si, Gyeonggi-do (KR)

(21) Appl. No.: 18/841,181

(22) PCT Filed: Feb. 10, 2023
(86) PCT No.: PCT/KR2023/002001

§ 371 Date: Aug. 23, 2024

(30) Foreign Application Priority Data
Feb. 23, 2022 (KR) 10-2022-0023957

(51) Int. Cl. A61H 39/06

(52) U.S. Cl. CPC A61H 39/06

(57) ABSTRACT

A red hot needle and a method for manufacturing the same wherein the red hot needle is provided with a heated needle handle located on top of a needle handle, so that heat applied to the heated needle handle diffuses into the needle handle and is slowly transferred to the needle body, thereby inhibiting a patient from being burned by the heat. The needle body is made of gold having relatively high abrasion resistance and tension, so that pain caused by insertion of the needle body is reduced. The a needle handle has greater thickness than the needle body, and the heated needle handle has lesser thickness than the needle handle. The method for manufacturing includes making the needle body of gold, making the needle handle and the heated needle handle of silver, attaching the needle body to the needle handle, and removing impurities from the needle by means of acidification.

### TECHNICAL FIELD

The present invention relates to a red hot needle and a method for manufacturing the same wherein as heat applied from the outside is applied to the red hot needle inserted into acupuncture points, the red hot needle performs both of acupuncture and moxibustion to transfer the heat to the dermis where the acupuncture points are located, more specifically to a red hot needle and a method for manufacturing the same wherein the red hot needle is provided with a heated needle handle that is located additionally on top of a needle handle, so that the heat primarily applied to the heated needle handle is diffused into the needle handle and then transferred to a needle body, thereby preventing a patient from having a burn caused by the heat of the needle body, and provided with the needle body that is not made of silver having relatively low abrasion resistance and tension, but made of gold having relatively high abrasion resistance and tension, so that the patient's pain caused by the insertion of the needle body can be reduced.

### BACKGROUND ART

An acupuncture technique applies accurate stimulation onto acupuncture points related to an affected area of a patient according to his or her symptoms and the position of the affected area and thus activates biological responses, and generally, the acupuncture technique is classified into a method for inserting a needle into acupuncture points and a method for applying moxa to acupuncture points.

The method for inserting a needle into acupuncture points makes use of only the stimulation of the needle, without any use of heat, so that an appropriate curative efficacy in relieving symptoms may be not obtained, and the method for applying moxa to acupuncture points is carried out in a state where the moxa is touched with the skin or is almost touched with the skin, so that a patient may be burned easily and heat is dispersed into the skin around the acupuncture points, without being transferred to the dermis of the skin, thereby failing to obtain a good curative efficacy.

To solve such problems, fire needle acupuncture has been proposed. The fire needle acupuncture is an acupuncture technique wherein as heat applied from the outside is applied to a red hot needle inserted into acupuncture points, the red hot needle performs both of acupuncture and moxibustion to transfer the heat to the dermis where the acupuncture points are located. The efficacy of the fire needle acupuncture has been already known and proved through different types of media and clinical trials, and a detailed explanation of the efficacy will be avoided.

One example of conventional red hot needles is disclosed in Korean Patent Application Laid-open No. 10-2001-0086886 (Sep. 15, 2001) wherein a red hot needle includes a body having a needle tip on one end thereof in such a way as to be inserted into the affected area of a patient and a needle handle located on the other end of the needle body.

Another example of conventional red hot needles is disclosed in Korean Patent No. 10-0988310 (Oct. 11, 2010) wherein a heated needle includes a needle body made of a metal and having a needle handle and a needle bar and a coating layer formed on the outer surface of the needle handle in such a way as to absorb external radiation heat and transfer the heat through the needle handle and the needle bar.

Yet another example of conventional red hot needles is disclosed in Korean Patent Application Laid-open No. 10-2021-0067128 (Jun. 8, 2021) wherein a heated needle includes a needle part made of a metal and a coating layer for coating at least a portion of the needle part, generating heat, and thus raising a temperature of the needle part.

In the case of the above-mentioned conventional red hot needles, however, the heat applied primarily to the needle handle having relatively great thickness is transferred to the needle body having relatively less thickness, so that the needle body inserted into the tissues underneath the skin is quickly heated to a high temperature, thereby causing a patient to be burned.

In the case of the above-mentioned conventional red hot needles, further, the needle body inserted into the tissues underneath the skin is made of silver having relatively low abrasion resistance and tension, so that a patient's pain may be caused by the insertion of the needle body.

### PRIOR ART LITERATURE

### Patent Literature

(Patent Literature 0001) 1. Korean Patent Application Laid-open No. 10-2001-0086886 (Sep. 15, 2001)
(Patent Literature 0002) 2. Korean Patent No. 10-0988310 (Oct. 11, 2010)
(Patent Literature 0003) 3. Korean Patent Application Laid-open No. 10-2021-0067128 (Jun. 8, 2021)

### DISCLOSURE

### Technical Problem

Accordingly, it is an object of the present invention to provide a red hot needle and a method for manufacturing the same wherein the red hot needle is provided with a heated needle handle that is located additionally on top of a needle handle, so that the heat primarily applied to the heated needle handle is diffused into the needle handle and then transferred to the needle body, thereby preventing a patient from having a burn caused by the heat of the needle body, and provided with the needle body that is not made of silver having relatively low abrasion resistance and tension, but made of gold having relatively high abrasion resistance and tension, so that the patient's pain caused by the insertion of the needle body can be reduced.

### Technical Solution

The above-mentioned object of the present invention is accomplished by a red hot needle including a needle body inserted into tissues beneath the skin, a needle handle located on top of the needle body and having relatively greater thickness than the needle body, and a heated needle handle located on top of the needle handle and having relatively lesser thickness than the needle handle.

According to desirable characteristics of the present invention, the needle body may be made of gold and the needle handle and the heated needle handle may be made of silver.

According to desirable characteristics of the present invention, the needle body may have length between 25 and 130 mm and thickness between 0.2 and 1.0 mm.

According to desirable characteristics of the present invention, the needle handle may have the shape of a cylinder.

According to desirable characteristics of the present invention, the needle handle may include three flat plates spaced apart from one another and two rhombuses for connecting the three flat plates with one another.

According to desirable characteristics of the present invention, the heated needle handle may be twisted to form a spiral groove on the outer peripheral surface thereof.

The above-mentioned object of the present invention is accomplished by a method for manufacturing a red hot needle that includes a first step where the needle body is made of gold, a second step where the needle handle and the heated needle handle are made of silver, a third step where the needle body is attached to the needle handle to make the red hot needle, and a fourth step where impurities are removed from the red hot needle by means of acidification.

According to desirable characteristics of the present invention, in the third step, the needle body and the needle handle may be attached to each other by means of oxy-fuel welding.

According to desirable characteristics of the present invention, the method may further include a fifth step where the surface of the red hot needle is subjected to a glazing treatment.

### Advantageous Effects of Invention

According to the embodiment of the present invention, the red hot needle is provided with the heated needle handle that is located additionally on top of the needle handle and has relatively lesser thickness than the needle handle, so that the heat primarily applied to the heated needle handle is diffused into the needle handle and then slowly transferred to the needle body, thereby preventing a patient from having a burn caused by the heat of the needle body.

According to the embodiment of the present invention, the red hot needle is provided with the needle body that is not made of silver having relatively low abrasion resistance and tension, but made of gold having relatively high abrasion resistance and tension, so that the patient's pain caused by the insertion of the needle body can be reduced.

### BRIEF DESCRIPTION OF DRAWINGS

FIG. 1 is a perspective view showing a red hot needle according to an embodiment of the present invention.

FIG. 2 is a front view showing the red hot needle according to the embodiment of the present invention.

FIG. 3 is a perspective view showing a red hot needle according to another embodiment of the present invention.

FIG. 4 is a side view showing a method for using the red hot needle according to the embodiment of the present invention and an operation of the red hot needle.

FIG. 5 is a flowchart showing a method for manufacturing a red hot needle according to an embodiment of the present invention.

### MODE FOR INVENTION

Hereinafter, example embodiments of the present invention will be described in detail with reference to the accompanying drawings. An embodiment of the present invention as will be discussed later will be in detail described so that it may be carried out easily by those having ordinary skill in the art, and therefore, this does not limit the idea and technical scope of the invention.

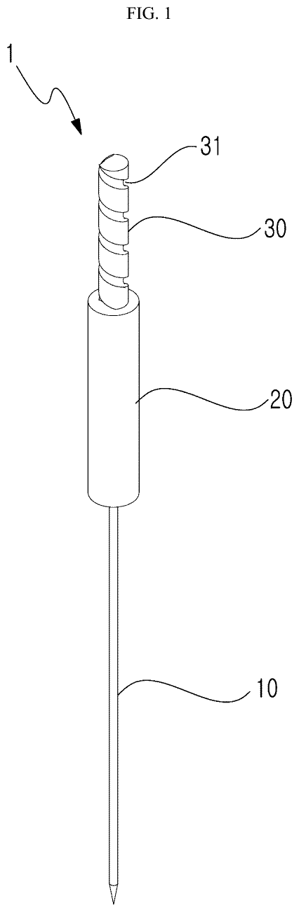

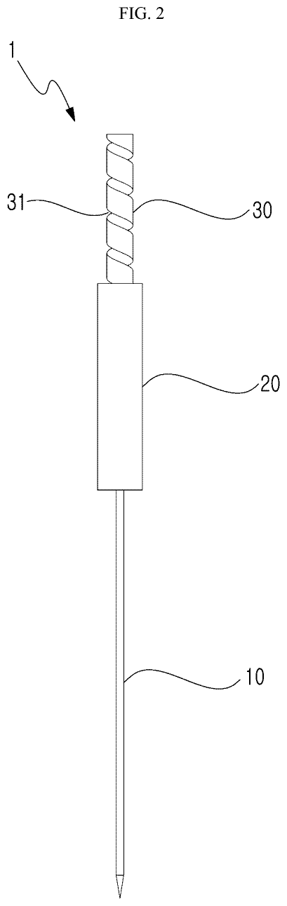

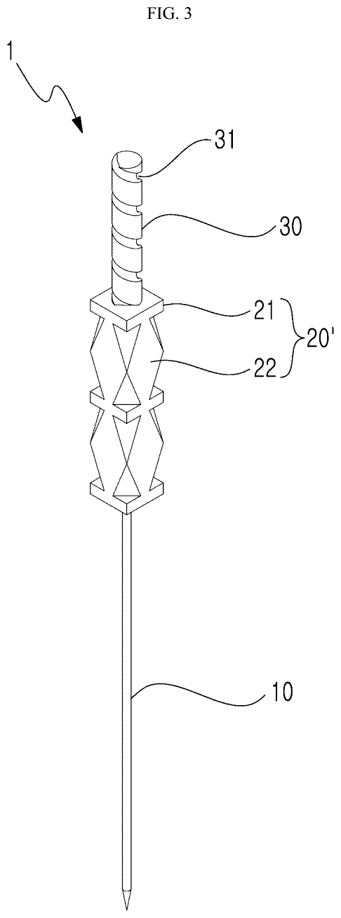

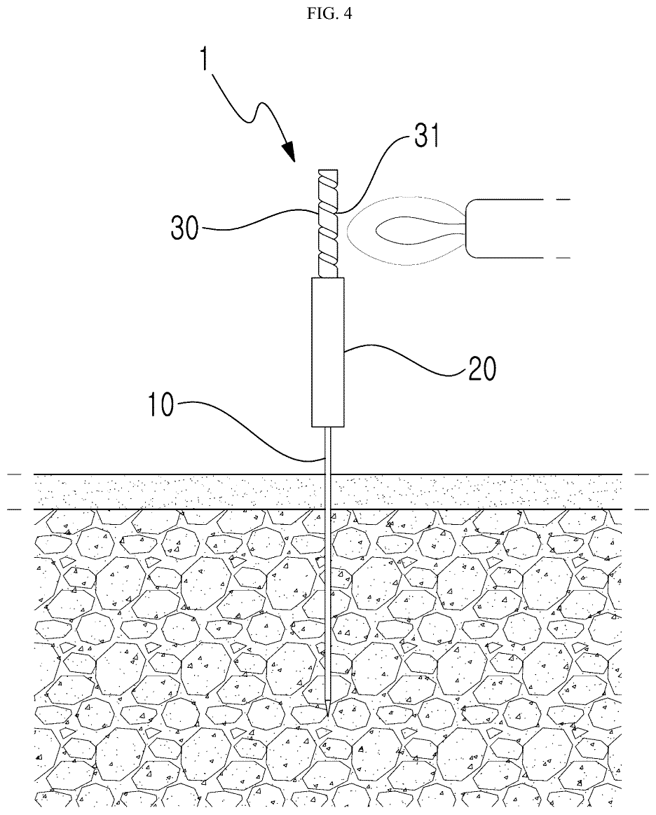

FIG. 1 is a perspective view showing a red hot needle according to an embodiment of the present invention, FIG. 2 is a front view showing the red hot needle according to the embodiment of the present invention, FIG. 3 is a perspective view showing a red hot needle having a differently-shaped needle handle according to another embodiment of the present invention, and FIG. 4 is a side view showing a method for using the red hot needle according to the embodiment of the present invention and an operation of the red hot needle.

As shown in FIGS. 1 to 4, a red hot needle 1 according to an embodiment of the present invention includes a needle body 10 inserted into tissues beneath the skin, a needle handle 20 or 20′ located on top of the needle body 10 and having relatively greater thickness than the needle body 10, and a heated needle handle 30 located on top of the needle handle 20 or 20′ and having relatively lesser thickness than the needle handle 20 or 20′.

In this case, the needle body 10 is a needle that is inserted into tissues beneath the skin at acupuncture points of a patient and has a length between 25 and 130 mm and a thickness between 0.2 and 1.0 mm, while having a front sharp tip insertable beneath the skin.

The needle body 10 is made of a metal such as gold, silver, and the like, but preferably, the needle body 10 is not made of silver having relatively low abrasion resistance and tension, but made of gold having relatively high abrasion resistance and tension.

In this case, the needle body 10 is more preferably 14K or 18K gold plated through general gold crafting.

The needle handle 20 or 20′ is located on top of the needle body 10. The needle handle 20 or 20′ is a handle for grasping the red hot needle 1 according to the present invention and has relatively greater thickness than the needle body 10.

The needle handle 20 or 20′ serves to form a thermal buffer zone between the heated needle handle 30 and the needle body 10 to prevent the needle body 10 from being heated to a high temperature due to heat applied to the heated needle 30 and has relatively greater thickness than the needle body 10 and the heated needle handle 30.

As shown in FIGS. 1 and 2, the needle handle 20 preferably has the shape of a cylinder. In this case, the needle handle 20 is grasped by two fingers of a surgeon and inserted beneath the skin of a patient, so that the handle body 10 is easily rotated just by rubbing his or her two fingers on the needle handle 20, thereby advantageously achieving easy surgery.

To prevent the surgeon's fingers from slipping from the needle handle 20, the needle handle 20 having the shape of the cylinder is subjected to surface machining such as embossing, diagonal grating groove formation, and the like for increasing surface roughness.

Otherwise, the needle handle 20′ is configured to have flat plates 21 spaced apart from one another in such a way as to be connected by means of rhombuses 22, and as shown in FIG. 3, three flat plates 21 spaced apart from one another are connected in a line by means of two rhombuses 22. Such a shape of the needle handle 20′ serves to prevent the heat received from the heated needle handle 30 as will be discussed later from being quickly and excessively transferred to the needle body 10 as the heat is repeatedly diffused and converged through the needle handle 20′, thereby preventing the patient from having a burn caused by the heat of the needle body 10.

The needle handles 20 and 20′ are made of a metal such as gold, silver, and the like, but preferably, they are made of silver having a relatively low manufacturing cost.

The heated needle handle 30 is located on top of the needle handle 20 or 20′. The heated needle handle 30 is a portion where heat to be transferred to the needle body 10 for fire needle acupuncture is applied from the outside and has relatively lesser thickness than the needle handle 20 or 20′.

The heated needle handle 30 is preferably heated directly by the flame generated from a torch, a lighter, and the like, but it may be heated indirectly by moxa.

The heated needle handle 30 is preferably twisted to form a spiral groove 31 on the outer peripheral surface thereof so that thermal conduction is efficiently carried out.

In the same manner as the needle handles 20 and 20′, the heated needle handle 30 is made of a metal such as gold, silver, and the like, but preferably, it is made of silver having a relatively low manufacturing cost.

The needle handles 20 or 20′ and the heated needle handle 30 are made of silver and have an integral body with each other through general silver crafting. The needle handle 20 or 20′ connected integrally with the heated needle handle 30 is attached integrally to the needle body 10 through oxy-fuel welding.

As shown in FIG. 4, the red hot needle 1 according to the embodiment of the present invention first inserts the needle body 10 into acupuncture points and then applies direct heat of the flame generated from a torch or lighter to the heated needle handle 30.

The red hot needle 1 according to the embodiment of the present invention is provided with the heated needle handle 30 that is located on top of the needle handle 20 or 20′ and has relatively lesser thickness than the needle handle 20 or 20′, so that the heat primarily applied to the heated needle handle 30 is diffused into the needle handle 20 or 20′ having relatively greater thickness than the heated needle handle 30 and then slowly transferred to the needle body 10, thereby preventing the needle body 10 from being overheated and avoiding the patient from having a burn caused by the heat of the needle body 10.

The red hot needle 1 according to the embodiment of the present invention is provided with the needle body 10 that is not made of silver having relatively low abrasion resistance and tension, but made of gold having relatively high abrasion resistance and tension, so that the patient's pain caused by the insertion of the needle body can be reduced.

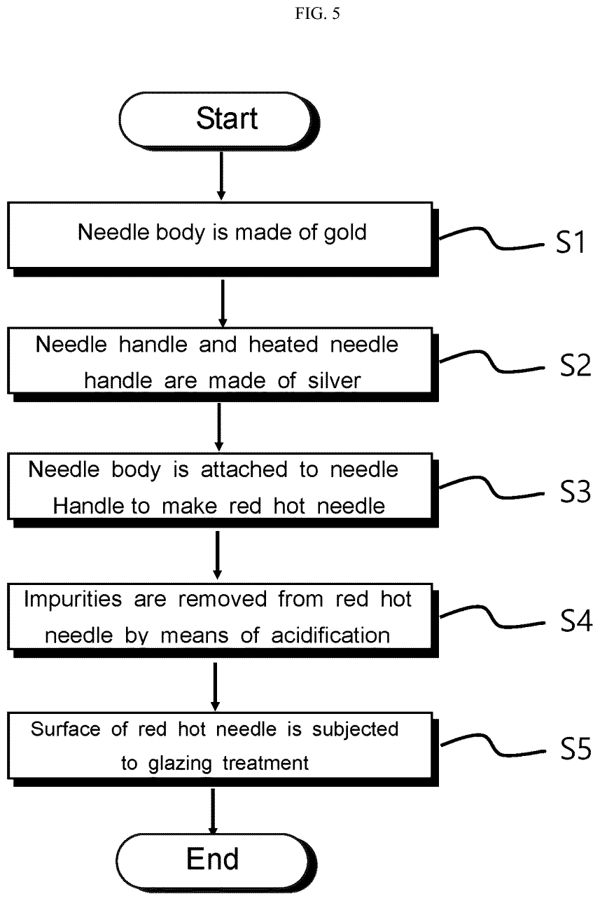

FIG. 5 is a flowchart showing a method for manufacturing a red hot needle according to an embodiment of the present invention.

As shown in FIG. 5, a method for manufacturing the red hot needle 1 according to an embodiment of the present invention includes a first step S1 where a needle body 10 is made of gold, a second step S2 where a needle handle 20 or 20′ and a heated needle handle 30 are made of silver, a third step S3 where the needle body 10 is attached to the needle handle 20 or 20′ to make the red hot needle 1, and a fourth step S4 where impurities are removed from the red hot needle 1 by means of acidification.

In this case, the needle body 10, which is made of gold in the first step S1, has length between 25 and 130 mm and thickness between 0.2 and 1.0 mm, while having a front sharp tip insertable beneath the skin.

The needle handle 20 or 20′, which is made of silver in the second step S2, has relatively greater thickness than the needle body 10 and the heated needle handle 30. In this case, the needle handle (with a reference numeral 20) has the shape of a cylinder, and the needle handle (with a reference numeral 20′) is configured to have three flat plates 21 spaced apart from one another in such a way as to be connected in a line by means of two rhombuses 22.

Further, the heated needle handle 30, which is made of silver in the second step S2, together with the needle handle 20 or 20′, has relatively lesser thickness than the needle handle 20 or 20′ and is twisted to form a spiral groove 31 on the outer peripheral surface thereof so that thermal conduction is efficiently carried out.

In the third step S3, the needle body 10 and the needle handle 20 or 20′ are attached to each other by means of oxy-fuel welding. In the fourth step S4, further, the red hot needle 1 after the third step S3 is submerged into an acid solution such as a cleaning liquid for cleaning noble metals such as gold, silver, and the like and then washed with water. According to the embodiment of the present invention, the method for manufacturing the red hot needle further includes a fifth step S5 where the surface of the red hot needle 1 is subjected to a glazing or unglazing treatment.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. For example, the UI or AI analysis model of the input part and the output part may be freely changed.

### EXPLANATIONS OF REFERENCE NUMERALS

1: Red hot needle
10: Needle body
20, 20′: Needle handle
21: Flat plate
22: Rhombus
30: Heated needle handle
31: Spiral groove
S1: First step
S2: Second step
S3: Third step
S4: Fourth step
S5: Fifth step

1. A red hot needle comprising:
a needle body (10) configured to be inserted into tissues beneath the skin;
a needle handle (20 or 20′) located on top of the needle body (10) and having relatively greater thickness than the needle body (10); and
a heated needle handle (30) located on top of the needle handle (20 or 20′) and having relatively lesser thickness than the needle handle (20 or 20′).

2. The red hot needle according to claim 1, wherein the needle body (10) is made of gold and the needle handle (20 or 20′) and the heated needle handle (30) are made of silver.

3. The red hot needle according to claim 1, wherein the needle body (10) has length between 25 and 130 mm and thickness between 0.2 and 1.0 mm.

4. The red hot needle according to claim 1, wherein the needle handle (20) has the shape of a cylinder.

5. The red hot needle according to claim 1, wherein the needle handle (20′) comprises three flat plates (21) spaced apart from one another and two rhombuses (22) for connecting the three flat plates (21) with one another.

6. The red hot needle according to claim 1, wherein the heated needle handle (30) is twisted to form a spiral groove (31) on the outer peripheral surface thereof.

7. A method for manufacturing the red hot needle according to claim 1, the method comprising:
obtaining a needle body (10) of gold;
obtaining a needle handle (20 or 20′) and heated needle handle (30) of silver;
attaching the needle body (10) to the needle handle (20 or 20′) to make the red hot needle (1); and
removing impurities from the red hot needle (1) by means of acidification.

8. The method according to claim 7, wherein the needle body (10) and the needle handle (20 or 20′) are attached to each other by means of oxy-fuel welding.

9. The method according to claim 7, further comprising applying a glazing treatment to the surface of the red hot needle (1).
